(19) United States
(12) Patent Application Publication
(10) Pub. No.: US 2004/0199441 A1
(43) Pub. Date: Oct. 7, 2004

(54) Minimizing the occurrence of retail pricing errors in electronic commerce

(75) Inventor: Jimmie Ray Mayfield, Lexington, KY (US)

Correspondence Address: IBM CORPORATION, IPLAW IQ0A/40-3, 1701 NORTH STREET, ENDICOTT, NY, 13760, US

(73) Assignee: International Business Machines Corporation, Armonk, NY

(21) Appl. No.: 10/406,762

(22) Filed: Apr. 3, 2003

(51) Int. Cl. G06F 17/60

(52) U.S. Cl. 705/35

(57) ABSTRACT

In a telephone order shopping system, an on-line shopping system, or a brick and mortar store that uses point of sale terminals, retail prices are compared with price bounds in order to guard against inappropriate retail prices caused by data-entry errors in a retail price database. The price bounds may be read directly from a price bound database or computed from antecedent data such as wholesale prices stored in the price bound database. When a retail price is found to violate an applicable price bound, the retail price is flagged for further evaluation.

### FIELD OF THE INVENTION

The invention applies generally to the field of electronic shopping, and more particularly to ensuring that correct prices are conveyed to shoppers who order by telephone, shop on-line over the Internet, or visit brick-and-mortar stores that use point-of-sale terminals.

### BACKGROUND

A consumer who engages in Internet shopping often uses a client that may include a web browser to access a server operated on behalf of a merchant. The server accepts orders and payments from the shopper, and displays a catalog. Generally the same configuration is used to support telephone shopping, with the principal difference being that a human agent provides an interface between the shopper and the catalog. In both cases, the catalog often accesses stored data that associates retail prices with catalog items, for example according to stock keeping unit (SKU) numbers. For convenience, this stored data may be called a retail price database, although the structure of the data need not necessarily be that of a database in a pedantic sense.

In much the same way, a brick-and-mortar store that uses a modern inventory tracking and point-of-sale system often relies on a central retail price database. A good example of such a system is described in U.S. Pat. No. 5,794,211 to Goodwin, et al. Such a system includes a central server that maintains a retail price database called a price-lookup file. Point-of-sale terminals access the price-lookup file to compute charges when shoppers check out. To display prices to shoppers before check out, such systems may post electronic price labels (EPL) in the shopping area, for example on shelves near the items to be sold. Prices displayed in this way may be changed readily by the merchant. In order to determine a retail price to be displayed at any particular time, an electronic price label may access a local EPL data file, which may be updated from the central retail price database.

The telephone shopping model, the Internet model, and the brick-and-mortar model suffer from a common problem: a retail price quoted by an agent, or put on a web page, or shown on an electronic price label may not agree with the price actually used to bill the shopper. For example, if a communication failure occurs around the time that a price is changed, a situation may arise wherein one price is conveyed to a shopper and another price is used to compute the shopper's charges. Needless to say, shoppers find this very disagreeable, especially when the second price is higher than the first.

The problem regarding consistency of retail prices at various points in an electronic shopping system has been solved by Goodwin, as described in the aforementioned U.S. Pat. No. 5,794,211, and by others. Despite this good work, a related problem remains. The problem, which arises when data is entered incorrectly into the retail price database, has great importance from the point of view of the merchant. Even though prices may be quite incorrect, constraints such as those imposed on electronic shopping systems by Goodwin are satisfied as long as the same incorrect prices are propagated throughout the electronic shopping system.

A price entered incorrectly into the retail price database may be absurdly low or prohibitively high. When a price is too low, the merchant may risk significant financial loss in honoring the low price, especially in the case of Internet shopping where orders may pour in at a high rate once the mistake is discovered by an affinity group of consumers. If the merchant does not honor the low price, the net result may be significant loss of goodwill. On the other hand, a prohibitively high price may cause an item to stop selling, and cause the merchant to be perceived by consumers as being uncompetitive.

Thus there is a need for a way to detect incorrect entry of prices into a retail price database used in electronic an shopping system, and to minimize the consequences of such incorrect entries.

### SUMMARY

The present invention improves electronic shopping systems by guarding against incorrect entry of prices into a retail price database.

According to the invention, price bounds are applied in an electronic shopping system that has a retail price database. In a preferred embodiment of the invention, the price bounds are computed from wholesale prices and stored in a price bound database. A price bound may be an upper bound that a retail price must not exceed, a lower bound that a retail price must exceed, or a range of prices that must contain the retail price. When the retail price of an item is entered into the retail price database for the first time, or when the price is subsequently changed in the retail price database, the retail price is compared with the price bound for that item read from the price bound database. If the retail price violates the price bound, the retail price is flagged for further evaluation. Thus the present invention protects a merchant against the adverse consequences of absurdly low retail prices or prohibitively high retail prices caused by data-entry errors.

### BRIEF DESCRIPTION OF THE DRAWINGS

FIG. 1 is a block diagram that shows exemplary use of the invention in a context of telephone or Internet on-line shopping.

FIG. 2 is a block diagram that shows exemplary use of the invention in a context of brick-and-mortar shopping.

FIG. 3 is a flowchart that shows steps of a method according to the invention for application to the exemplary structures described in FIG. 1 and FIG. 2.

### DETAILED DESCRIPTION

The present invention ensures that retail prices for telephone shopping, on-line shopping, and brick-and-mortar shopping conform to price bounds deemed acceptable by the selling merchant, thereby minimizing any adverse consequences of absurdly low prices or prohibitively high prices caused by errors in entering retail prices in a retail price database. Although the invention is described here in the interest of clarity using the notions of retail shopping, the invention applies as well to other kinds of electronic commerce, specifically including business-to-business to-business electronic commerce.

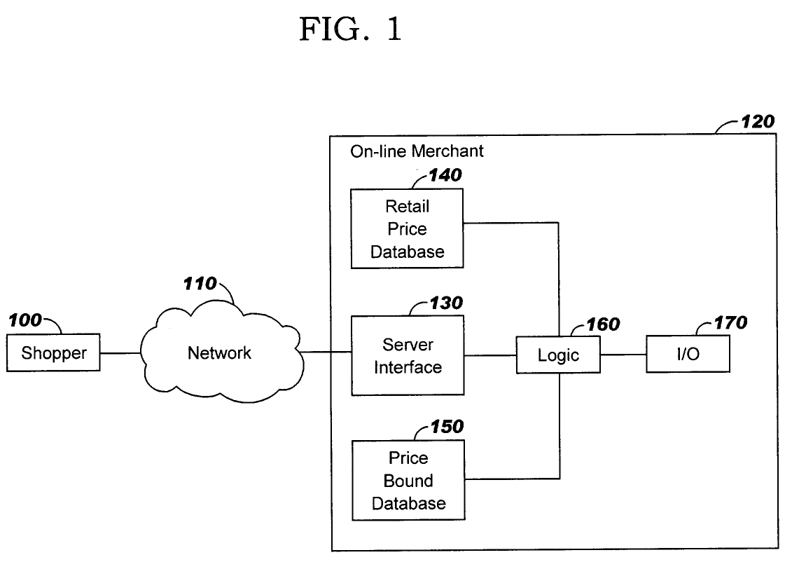

FIG. 1 is a block diagram that shows exemplary use of the invention in a context of Internet on-line shopping or telephone shopping, the principal difference between the two contexts being that a human agent provides an interface between a telephone shopper and a merchant. As shown in FIG. 1, a shopper 100 connects, through a communication network 110 such as the public service telephone network or the Internet, to a merchant 120. Here, the term “shopper” refers broadly to machines, humans, or machines operated by humans, and the term “merchant” refers broadly to humans who operate on-line or telephone-order businesses, as well as to the required electronic data processing equipment.

Typically in on-line shopping, the shopper 100 is a human who uses a personal computer that is equipped with a web browser. The merchant 120 includes a server interface 130 connected to the Internet 110. The server interface 130 provides a store front of on-line shopping services to the shopper 100, such as presentation of a catalog, operation of an electronic shopping cart, collection of shipping and payment information, and so forth. The merchant 120 also includes a retail price database 140, a price-bound database 150, logic 160 such as a stored program controlled processor, and an Input/Output (I/O) interface 170 such as a keyboard and visual display.

Components of the merchant 120 are shown as being separate entities in FIG. 1 only for the purpose of descriptive clarity. Various of these components may be grouped together in various combinations. For example, the server interface 130, the retail price database 140, the price-bound database 150, the logic 160, and the I/O interface 170 may all be included in a single machine such as an Internet server, a high-performance personal computer, or a special-purpose workstation. Also, the term database is used here is a wide rather than a pedantic sense, and indicates stored data that is indexed for access; a full-function relational database is not required.

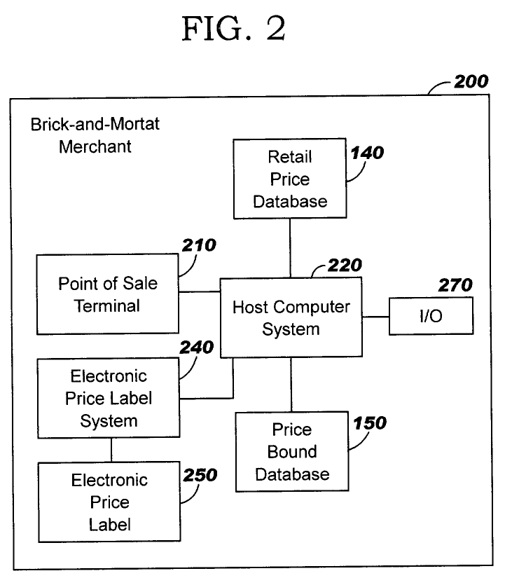

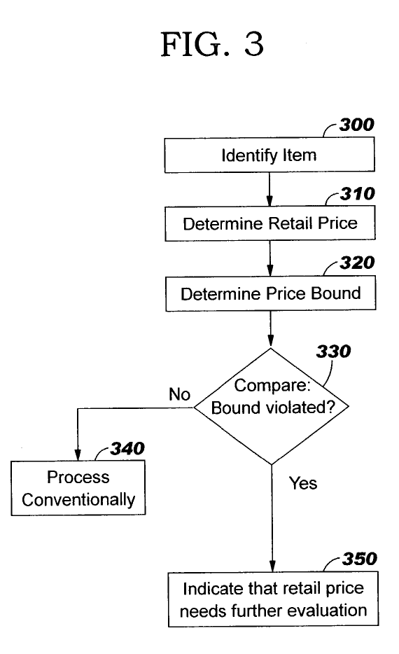

FIG. 2 is a block diagram that shows exemplary use of the invention in a context of brick-and-mortar shopping. As shown in FIG. 2, a brick-and-mortar merchant 200 may include a point-of-sale (POS) terminal 210 for checking out shoppers (not shown). When a shopper presents an item to the POS terminal 210, the POS terminal 210 identifies the item, for example by a bar-coded SKU, and queries a host computer 220 in order to find the item's retail price. The host computer 220 accesses a retail price database 140, and returns the retail price to the POS terminal 210. The host computer 220 may also access a price-bound database 150, as described below with reference to FIG. 3. FIG. 2 also shows an Input/Output (I/O) interface 270, which may include a keyboard and a visual display, and which may be used, for example, to operate the host computer 220, to enter and change prices in the retail price database 140 and the price bound database 150, and so forth. Again, the various components of the merchant 200 are shown in FIG. 2 as being separate entities only for the purpose of descriptive clarity. Various components may be grouped together in various combinations. For example, various combinations of the components may be included in a single machine. Also, the term database is used here is a wide rather than a pedantic sense, and indicates stored data that is indexed for access; a full-function relational database is not required.

The host computer 220 may also support an electronic price label (EPL) system 240, which provides an electronic price label 250 displayed in the shopping area near the item that is to be sold. The EPL system 240 may include an EPL date file which stores retail prices. The EPL data file may be updated by the host computer 220 from the retail price database 140. Inclusion of EPL data files in the EPL system 240 would be typical in a configuration where one host computer 220 supported a plurality of EPL systems, for example where EPL systems were distributed over a plurality of store locations.

FIG. 3 is a flowchart that shows steps of a method according to the invention for application to the exemplary structures described in FIG. 1 and FIG. 2. One purpose of this method is to ensure that retail prices conveyed to the shopper are reasonable, meaning that these prices do not violate limits acceptable to the merchant. The steps of the method may be executed each time an item is checked out, or the steps may be executed when a retail price for a new item is entered in the retail price database 140, or when a price in the retail price database 140 is changed, or executed at scheduled times or at random times, and so forth. In the context of FIG. 1, the steps may be executed by the logic 160; in the context of FIG. 2, the steps may be executed by the host computer 220.

Accordingly, an item in question is identified (step 300), for example by its SKU number. The retail price of the item is determined (step 310). The retail price may be an entry that is read from the retail price database 140, or may be a proffered entry to the retail price database 140 or a proffered change to an entry in the retail price database 140. A price bound for the item is determined (step 320). It is important to note that the price bound for the item may be determined by reading a price bound directly from the price-bound database 150 which may store price bounds, or may be computed from antecedent data stored in the price bound database 150. In the latter case, the price-bound database 150 may store wholesale prices, for example, from which the price bounds may be computed as part of step 320. For example, an entry in the price bound database 150 for a particular item may be its wholesale price, from which an upper bound of four-times-wholesale-price may be computed in step 320. In other examples, a lower bound may be computed from the wholesale price, or a range of suitable prices (i.e., both an upper bound and a lower bound) may be computed in step 320 from the wholesale price of the item. The invention is intended to encompass other price bounds as well as these exemplary price bounds, such as price bounds determined by mandating satisfaction of a stated minimum profit or mark-up, price bounds computed by applying incentives or discounts to earlier retail or wholesale prices, and price bounds derived from prices of similar goods or services already included in the retail price database 140 or the price bound database 150.

The retail price and the price bound are then compared (step 330). If the retail price does not violate the price bound, for example if the retail price is above a lower bound, below an upper bound, or within an acceptable range, processing by the electronic shopping system continues conventionally (step 340). Otherwise (i.e., the retail price violates the price bound), indication is given that the retail price needs further evaluation (step 350), which further evaluation may be immediate or deferred, and which further evaluation may be manual or automatic. Indication may be given by displaying an error message on the I/O interface 170, 270, or by sending an email to an administrator, or by halting a shopping transaction in progress until the discrepancy can be resolved, and so forth. Although an indication that a retail price violates a price bound suggests that the retail price may have been entered incorrectly into the retail price database 140, the violation may instead indicate that the price bound itself is improper, for example because a wholesale price or other antecedent data was entered incorrectly into the wholesale price database 150.

From the foregoing description, those skilled in the art will now understand that the present invention guards against inappropriate retail prices. The foregoing description is illustrative rather than limiting, however, and the invention is limited only by the claims that follow.

I claim:

1. A method for determining whether retail prices are reasonable for items sold using an electronic shopping system having a retail price database, comprising:
determining a retail price of an item;
determining a price bound for the item;
comparing the retail price with the price bound; and
if the retail price violates the price bound, indicating that the retail price needs further evaluation.

2. The method of claim 1, wherein the step of determining a price bound is executed responsive to a price change for the item.

3. The method of claim 1, wherein the step of determining a price bound includes a step of reading the price bound from a price bound database.

4. The method of claim 1, wherein the step of determining a price bound includes a step of computing the price bound from antecedent data read from a price bound database.

5. The method of claim 4, wherein the antecedent data includes a wholesale price of the item.

6. The method of claim 1, wherein the price bound is an upper bound.

7. The method of claim 1, wherein the price bound is a lower bound.

8. The method of claim 1, wherein the price bound is a range of prices having an upper bound and a lower bound.

9. The method of claim 1,wherein the step of indicating includes a step of displaying an error message.

10. The method of claim 1,wherein the step of indicating includes a step of sending an email message.

11. The method of claim 1,wherein the step of indicating includes a step of halting a shopping transaction in progress.

12. A program storage device readable by a machine, tangibly embodying a program of instructions executable by the machine to perform method steps for determining whether retail prices are reasonable for items sold using an electronic shopping system, said method steps comprising:
determining a retail price of an item;
determining a price bound for the item;
comparing the retail price with the price bound; and
if the retail price violates the price bound, indicating that the retail price needs further evaluation.

13. The method of claim 12, wherein the step of determining a price bound includes a step of reading the price bound from a price bound database.

14. The method of claim 12, wherein the step of determining a price bound includes a step of computing the price bound from antecedent data read from a price bound database.d of claim 12, wherein the step of determining a price bound includes a step of computing the price bound from antecedent data read from a price bound database.

15. The method of claim 14, wherein the antecedent data includes a wholesale price of the item.

16. A retail shopping system, comprising:
a retail price database for storing retail prices of items sold using the retail shopping system;
a price bound database for storing price bound information pertaining to the items sold using the retail shopping system; and
logic for comparing a retail price of an item to be sold with a price bound derived from price bound information read from the price bound database, and indicating that the retail price needs further evaluation if the retail price violates the price bound.

17. The system of claim 16, where the price bound information stored in the price bound database includes the price bound.

18. The system of claim 16, where the price bound information stored in the price bound database includes antecedent information, and wherein the logic computes the price bound using the antecedent information.

19. The system of claim 16, wherein the antecedent information includes a wholesale price.

20. The method of claim 16,wherein the logic causes display of an error message when the retail price violates the price bound.

21. The method of claim 16, wherein the logic causes an email message to be sent when the retail price violates the price bound.

22. The method of claim 16,wherein the logic halts a shopping transaction in progress when the retail price violates the price bound.
